(19) United States
(12) Patent Application Publication
(10) Pub. No.: US 2008/0297525 A1
(43) Pub. Date: Dec. 4, 2008

(54) Method And Apparatus For Reducing Accesses To A Frame Buffer

(76) Inventor: Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/755,991

(22) Filed: May 31, 2007

(51) Int. Cl. G06F 13/36

(52) U.S. Cl. 345/534; 345/501; 345/531

(57) ABSTRACT

An apparatus comprises a first unit to receive a first frame. The first unit replaces each datum of the first frame with a datum having a particular value if the datum of the first frame is within a region of the first frame. A second frame is thereby created. The first unit also writes the second frame.

### FIELD

The present disclosure relates to reducing accesses to a memory used for storing a frame of image data.

### BACKGROUND

Often, a computer system that is capable of displaying computer graphics includes a display controller and a memory for storing a frame of image data (“frame buffer”). An image data source, such as a central processing unit (“CPU”), stores the image data in the frame buffer and subsequently the stored image data is fetched by the display controller and transmitted to a display device. The amount of power consumed by a memory depends in part on the number of times the memory is accessed. Reducing the total number of memory accesses reduces the amount of power consumed by the memory.

Several different devices, for example, the CPU, the display controller, and a camera module may need to access the frame buffer at different times. The clock rate of the memory must be set sufficiently high so that the expected peak memory bandwidth can be accommodated. Memory bandwidth refers to the number of memory accesses within a given time period. To the extent that the expected peak bandwidth can be reduced, the rate at which the memory is clocked may be lowered. As the amount of power a memory consumes also partially depends on the rate at which the memory is clocked, reducing the expected peak bandwidth also saves power.

Accordingly, there is a need for methods and apparatus for reducing accesses to and the clock frequency of a memory used for storing a frame of image data.

### SUMMARY

One embodiment is directed to a method that includes a step of receiving a first sequence of data of a first frame. The first sequence is in a particular order and each datum of the first frame has a value that is distinct from a particular value. A determination is made whether the data of the first frame are within a region of the first frame. Each datum of the first sequence that is within the region is replaced with the datum having the particular value. A second sequence of data is thereby created.

Another embodiment is directed to an apparatus that includes a first unit to receive a first frame. The first unit replaces each datum of the first frame with a datum having a particular value if the datum of the first frame is within a region of the first frame. A second frame is thereby created. The first unit also writes the second frame.

Yet another embodiment is directed to a system that includes a first memory. The first memory reads data of a first frame in a particular sequence. The first memory determines if each datum of the first frame is within a region of the first frame. The first memory stores a datum having a particular value if the datum is within the region and otherwise stores the datum.

This summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a simplified block diagram of an exemplary computer system, which includes a display device and a display controller that includes a frame buffer and a solid fill unit, according to one embodiment of the present disclosure.

FIG. 2 is a simplified block diagram of the display device and display controller of FIG. 1.

FIG. 3 is a simplified representation of image data stored in the frame buffer and a corresponding image rendered on the display device of FIG. 2.

FIG. 4 is a second simplified representation of image data stored in the frame buffer and a corresponding image rendered on the display device of FIG. 2.

FIG. 5 is a simplified block diagram of the display controller of FIG. 1 which includes a simplified block diagram of the solid fill unit.

In the drawings and description below, the same reference numbers are used in the drawings and the description generally to refer to the same or like parts, elements, or steps.

### DETAILED DESCRIPTION

A “frame” of image data generally includes a rectangular array of small picture elements or “pixels.” The frame may be stored in the frame buffer in the same arrangement in which the pixels are rendered on a display screen, i.e., as a rectangular array. The attributes of each pixel, such as its brightness and color, are represented by a numeric value. These values may be any number of bits. For example, in a bi-level image each pixel is defined by a single bit, while in a color image each pixel may be defined by 16 or 24 bits. In this description, a gray scale pixel or a pixel defined in a color space such as, for example, the RGB, YUV, CMY, HSV, YIQ, and HLS color models, is referred to as a two-dimensional pixel. A pixel that is additionally defined in terms of values that provide depth cues, such as, for example, texture, illumination, and shading, is referred to as a three-dimensional pixel.

Image data is typically fetched from the frame buffer and presented to the display device in “raster” order. A raster scan pattern begins with the left-most pixel on the top line of the array, and proceeds pixel-by-pixel from left to right. When the end of the top line is reached, the scan pattern moves to next lower line and again beginning with the left-most pixel proceeds from left to right. The pattern repeats with each lower line until the end of the frame is reached. The display of a static image may require just one frame of pixels while the display of a video image requires multiple frames.

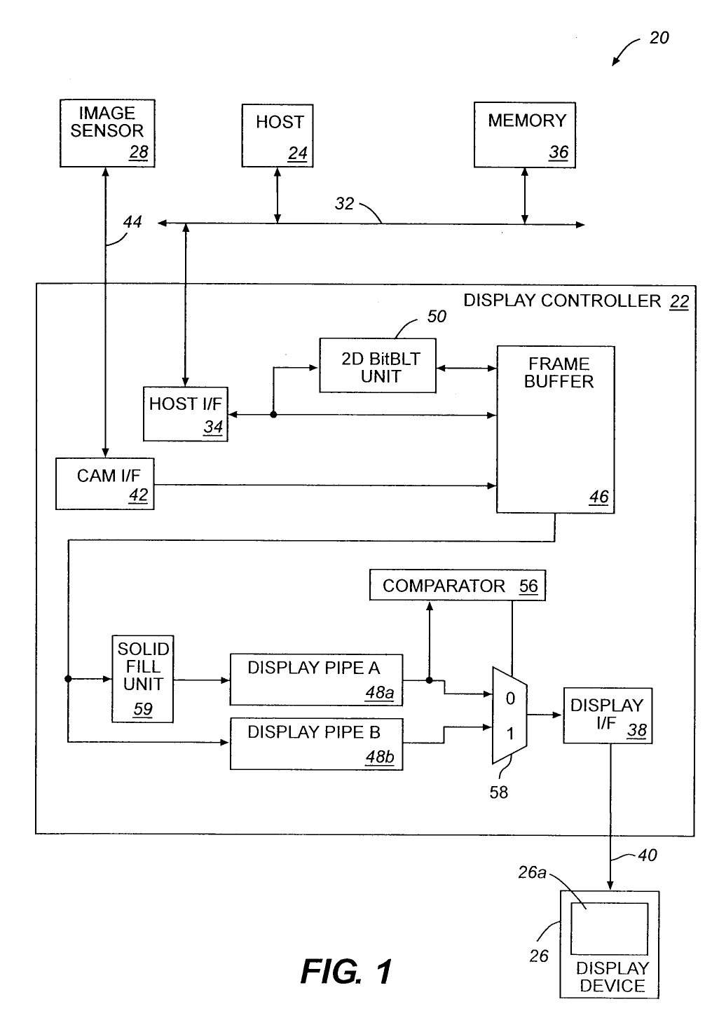

FIG. 1 is a simplified block diagram of an exemplary computer system 20 according to one embodiment of the present disclosure. The system 20 may be a mobile device (defined below). Where the system 20 is a mobile device, it is typically powered by a battery (not shown). The system 20 may include an exemplary display controller 22, a host 24, at least one display device 26 and one or more image data sources, such as image sensor 28.

The display controller 22 interfaces the host 24 and image sensor 28 with the display device 26. In one embodiment, the display controller 22 is a separate integrated circuit from the remaining elements of the system, that is, the display controller may be remote from the host, the image sensor, and the display device.

The host 24 may be a microprocessor, a digital signal processor, a CPU, a computer, or any other type of device or machine that may be used to control or direct some or all of the operations in a system. Typically, the host 24 controls operations by executing instructions that are stored in or on a machine-readable medium. The host 24 communicates with the display controller 22 over a bus 32 to a host interface 34 within the display controller 22. Other devices may be coupled with the bus 32. For instance, a system memory 36 may be coupled with the bus 32. The memory 36 may, for example, store instructions or data for use by the host 24 or image data that may be rendered using the display controller 22. The memory 36 may be an SRAM, DRAM, Flash, hard disk, optical disk, floppy disk, or any other type of memory.

A display device interface 38 is included in the display controller 22. The display device interface 38 provides an interface between the display controller 22 and the display device 26. A display device bus 40 couples the display controller 22 and the display device 26. A Liquid Crystal Display (“LCD”) is typically used as the display device in mobile devices, but the display device 26 may be any type of display device (defined below). An image may be rendered on a display screen 26a of the exemplary display device 26.

The image sensor 28 may be, for example, a charge-coupled device or a complementary metal-oxide semiconductor sensor. A camera interface 42 (“CAM 1/F”) is included in the exemplary display controller 22. The camera interface 42 is coupled with the image sensor 28 and receives image data output on data lines of a bus 44. Typically, the camera interface 42 also receives vertical and horizontal synchronizing signals from the image sensor 28 and provides a clocking signal to the image sensor 28 for clocking image data out of the sensor. These signals may be transmitted via the bus 44 or via a separate bus (not shown).

A memory 46 that is used for storing a frame of image data, i.e., a frame buffer, may be included within the display controller 52. However, it is not essential that the frame buffer 46 be disposed within the display controller 52. In alternative embodiments, the frame buffer 46 may be remote from the display controller. While the frame buffer 46 may be used for storing image data, it may also be used for storing other types of data. The capacity of the frame buffer 46 may vary in different embodiments. In one embodiment, the frame buffer 46 has a capacity which is sufficient to store no more than one frame of image data at a time, the frame size being defined by the display device 26. In another embodiment, the frame buffer 46 has a capacity to store one frame of image data and some additional data, but the capacity is not sufficient to store two frames of image data. In an alternative embodiment, the frame buffer 46 may have a capacity which is sufficient to store more data than a single frame of image data. The frame buffer 46 may be of the SRAM type. In addition, the frame buffer 46 may also be a DRAM, Flash memory, hard disk, optical disk, floppy disk, or any other type of memory.

One or more “display pipes” 48 may be included in the display controller 22. In the exemplary system 20, the display controller 22 includes display pipes A and B, designated 48a and 48b respectively. The display pipe 48b may be coupled directly with the frame buffer 46 and the display interface 38 via a selecting circuit 58. The display pipe 48a may be coupled with the frame buffer 46 via a solid fill unit 59 and with the display interface 38 via the selecting circuit 58. In one embodiment, a display pipe 48 is a first-in, first-out memory. In alternative embodiments, a display pipe 48 may be an SRAM, DRAM, register(s) or any other type of read/write memory. In addition, a display pipe 48 may be an asynchronous memory, i.e., different clock rates may be used for reading and writing. In the exemplary system 20, data are read out of a display pipe at a pixel clock rate (“PCLK”) and are written to a display pipe at a memory clock rate (“MCLK”). This permits image data to be read from the frame buffer 46 at the clock rate used by the frame buffer and written to the display interface 38 at the clock rate used by the display device 26. While a display pipe 48 serves primarily to buffer previously rendered pixel data, it may include circuitry in addition to that required merely to store data. For example, circuitry may be provided within or associated with a display pipe 48 for read and write pointers, for full and empty flags, and for issuing read and write commands. However, a display pipe 48 typically does not include logic for rendering graphics primitives or for otherwise processing image data except as described in this disclosure. A display pipe 48 may also include circuitry for practicing the novel methods and apparatus for reducing accesses to a frame buffer that are described below. In addition, the display pipes 48a and 48b are typically sized to store two-dimensional, as opposed to three-dimensional, pixel data. The exemplary display pipes 48a and 48b may each hold sixteen to thirty-two pixels, though a particular pipe capacity is not critical. In one embodiment, the display pipes 48a and 48b may each hold up to one percent of a frame of image data. Operation of the display pipes 48a and 48b is further described below.

In the exemplary system 20, the frame buffer 46 is coupled with the host interface 34 and the camera interface 42. The host 24 or the image sensor 28 may store data in the frame buffer 46 via the host and camera interfaces 34 and 42, respectively. In addition, the host 24 may read data stored in the frame buffer 46 via the host interface 34.

A two-dimensional (“2-D”) BitBLT unit 50 may be included in the display controller 22. The BitBLT unit 50 may transfer a rectangular block of pixels from one region to another region within the frame buffer 46 or between the system memory 24 and the frame buffer 46. In addition, the 2-D BitBLT unit 50 may perform a “solid fill” operation, which is explained below. In other embodiments, the BitBLT unit 50 need not be provided in the display controller 22 or within the system 20.

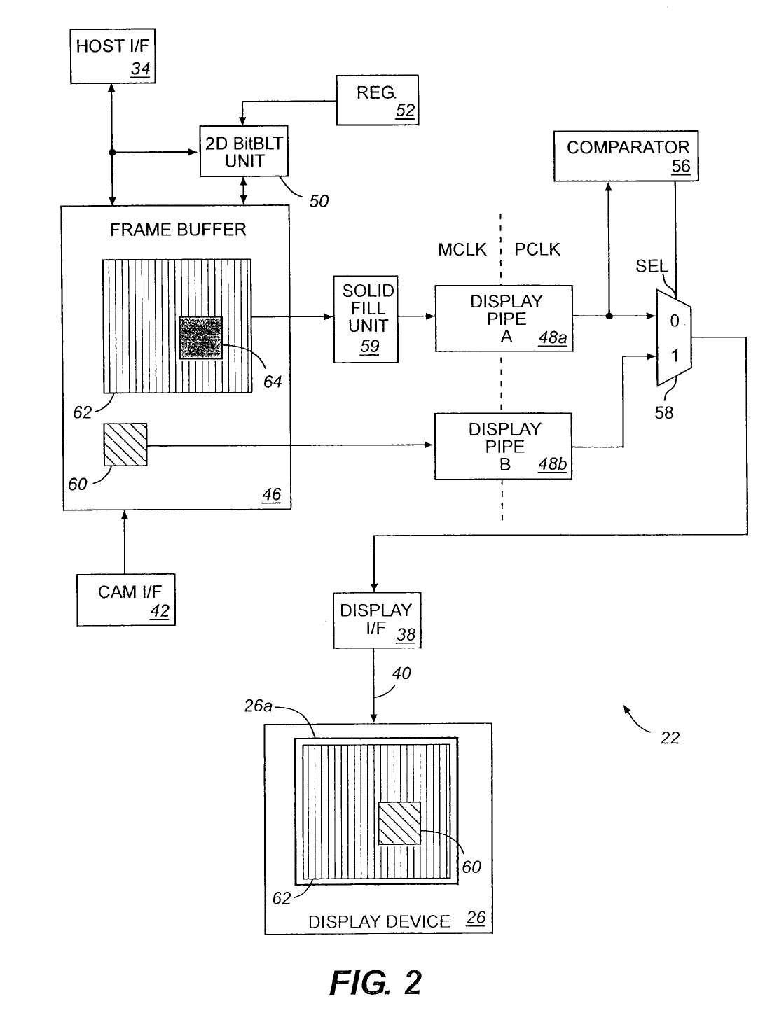

FIG. 2 is a simplified block diagram of the display device 26 and display controller 22 of the exemplary computer system 20 shown in FIG. 1. FIG. 2 serves to illustrate one example of how an overlay image may be superimposed on a main image for display on a display device.

As shown in FIG. 2, the 2-D BitBLT unit 50 is coupled with a register 52, which stores a single pixel and which is used with the solid fill operation. In the solid fill operation, the unit 50 copies the pixel stored in the register 52 to a particular memory location in the frame buffer 46. By repeatedly transferring a single pixel to a series of adjacent memory locations in the buffer, a multi-pixel area having the color of the pixel stored in register 52 may be created within the frame buffer 46. When the unit 50 copies the pixel to a memory location, the copy operation destroys whatever data was previously stored in the memory location. In addition, the unit 50 does not first read whatever data was previously stored in the memory location. The unit 50 performs its operations according to one or more memory addresses provided to it, but would be unable to perform its operations if it were instead provided with positional information with respect to data arranged in a two dimensional array (not corresponding with memory addresses), or with positional information with respect to an ordered sequence of data.

In the example of FIG. 2, an overlay image 60 and a main image 62 are stored in the frame buffer 46. In this example, the overlay image 60 may be a frame of video data received from the image sensor 28. The main image 62 may be a “computer generated” frame of image data received from the host 24. The frame buffer 46 shown in FIG. 2 has a capacity to store one frame for display on the display device 26 (main image 62) and some additional data (overlay image 60), but its capacity is not sufficient to store two frames for display on the display device 26. The overlay image 60 and a main image 62 may be comprised of pixel data, but in one embodiment, one or both of the images may not include pixel data having a particular value, such as the value of a single-colored portion 64 described below.

The main image 62 may be stored in the system memory 24, and the host 24 may issue a write instruction to cause the BitBLT unit 50 to copy the main image 62 from the system memory 24 to the frame buffer 46. Alternatively, the host 24 may write the main image 62 to the frame buffer 46. The main image 62 may represent an image comprised of icons, buttons, task bars, text, and the like on a background. Examples of these types of images include the name of the network operator, signal strength, battery charge level, and message and call indicators. The main image background may be a single color, a pattern, a photograph, or other image.

As shown in FIG. 2, part of the main image 62 is replaced with a single-colored portion 64, which may have the same dimensions as and correspond with the overlay image 60. As explained below, the location of the single-colored portion 64 with respect to the main image 62 in the frame buffer 46 determines the position of the overlay image 60 on the display screen 26a. To store the main image 62 with the single-colored portion 64 overlaying part of the main image as shown in FIG. 2, the host 24 may first store a complete main image 60 and then store the single colored portion 64. The host 24 may store the single-colored portion 64 in a series of write operations or it may issue a solid fill command to the BitBLT unit 50 to store the single colored portion 64. In either case, when the single-colored portion 64 is stored, it overwrites a portion of the previously stored main image 62. After the single-colored portion 64 is stored, it is no longer possible for the host to read the complete main image 60. If the host wishes to determine status or other information being displayed as part of the entire main image 60, it may need to determine this information in some other manner than by reading main image 60 from the frame buffer 46.

After the overlay image 60, the main image 62, and the single-colored portion 64 have been stored in the buffer, the display pipes 48a and 48b fetch image data, e.g. pixels, from the frame buffer 46. The display pipe 48a may request pixels of the main image 62 in a raster order corresponding to the main image, and the display pipe 48b may request pixels of the overlay image 60 in a raster order corresponding to the overlay image. In addition to raster order, the display pipes 48a and 48b may request pixels in alternate sequences, for instance, a rotated raster order, a reverse raster order, or an interlaced scan order. After the display pipes 48a and 48b are full, pixels are written to a selecting unit 58 in the order received and in synchronicity with the pixel clock. In the example shown in FIG. 2, the solid fill function of the unit 59 is not employed and main image pixels from the frame buffer 46 are passed through the solid fill unit 59 and presented to the pipe 48a. As each pixel of the main image is output from the pipe 48a, the value of the pixel is compared with a particular value by the comparator 56. The comparator 56 is coupled with the selecting input of the selecting circuit 58. If the pixel matches the particular value, e.g., the color of the single-colored portion 64, the comparator 56 selects a pixel from the display pipe 48b for presentation to the display interface 38. On the other hand, if the pixel does not match the value of the particular pixel, the comparator 56 selects a pixel from the display pipe 48a for presentation to the display interface 38. The display interface 38 transmits the pixel it receives from the selecting unit 58 to the display device 26, where an image comprised of the main and overlay images 62, 60 is rendered.

The location of the single-colored portion 64 with respect to the main image 62 in the frame buffer 46 determines the position of the overlay image 60 on the display screen 26a. As the display pipe 48a outputs pixels of the main image 62 in raster order, the comparator 56 selects a pixel for the current position in the sequence from the overlay image 60 if the pixel location corresponds with the single-colored portion 64. Otherwise, the comparator 56 selects a pixel of the main image 62.

Because the main image 62 typically fills the entire display screen 26a, generally it may not be repositioned. However, the overlay image 60, typically being smaller than the display screen, may be displayed in any desired region of the display screen 26a and its location on the display screen 26a may be controlled by a user. That is, the user may position the overlay image 60 so that it overlays any desired portion of the main image 62.

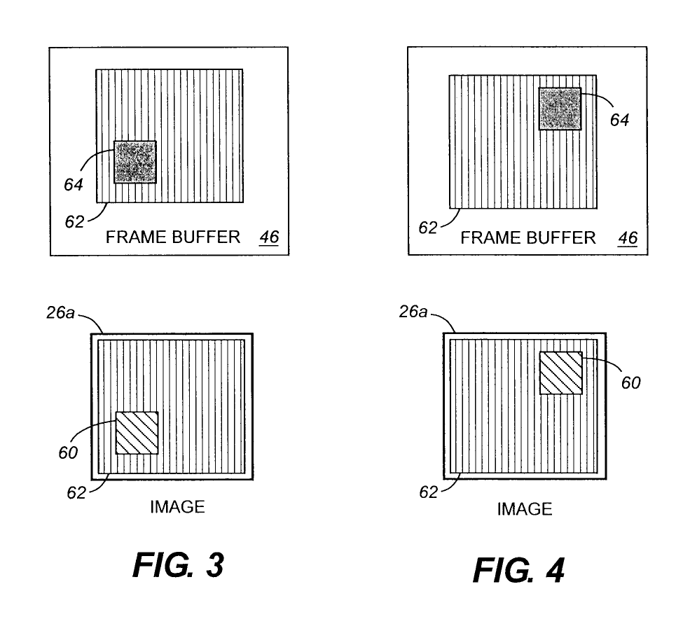

FIGS. 3 and 4 illustrate how changing the location in the frame buffer 46 where the single-colored portion 64 is stored changes the location on the display screen 26a where the overlay image 64 is rendered. In FIG. 3, the single-colored portion 64 is stored over pixels in the lower, left corner of the main image 62. As a result, the overlay image 60 appears in the lower, left corner of the display screen 26a. In FIG. 4, the single-colored portion 64 is stored over pixels in the upper, right corner of the main image 62. As a result, the overlay image 60 appears in the upper, right corner of the display screen 26a.

When it is desired to move the single-colored portion 64 so that it overlays a different portion of the main image 62, such as is shown in FIGS. 3 and 4, the host 24 may need to store another complete main image 62 and then store the single-colored portion 64 at the new location. Alternatively, the host may store a portion of the main image 62 and issue a solid fill command to the BitBLT unit 50 to store the single-colored portion 64 at the new location. In this alternative, the host may store only the portion of the main image 62 that was previously overlaid by the overlay image. However, regardless of which method is employed, it is generally necessary to write at least an entire display-sized frame of image data to the frame buffer 46 each time the single-colored portion 64 is moved. Additionally, it may require writing a frame the size of the overlay image. If these writes to the frame buffer could be reduced or eliminated, the amount of power consumed by the frame buffer would be reduced. In addition, reducing or eliminating these writes may well result in a reduction in the expected peak memory bandwidth. Reducing the expected peak memory bandwidth permits the rate at which the memory is clocked to be lowered, which would also reduce the amount of power consumed. Further, because it is not possible for the host to read the complete main image 60 after the single-colored portion 64 is stored, the host may need to re-determine or fetch from another source that part of the complete main image 60 overwritten with the single-colored portion 64 should the host need to read all or part of the main image.

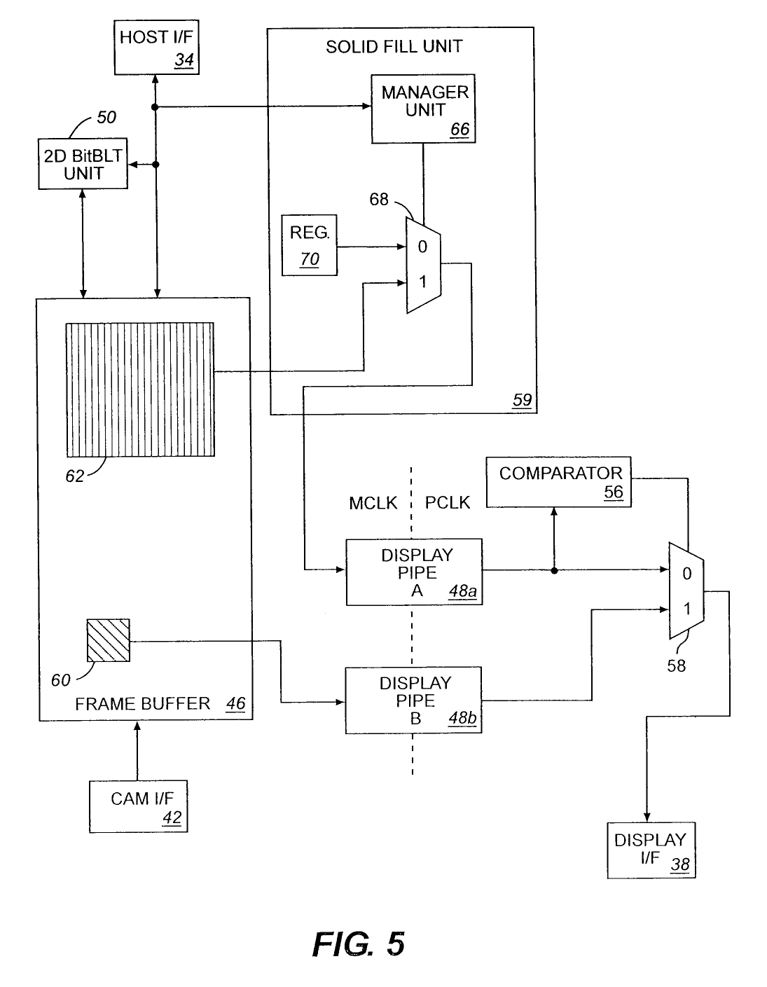

FIG. 5 is a simplified block diagram of the display controller 22, which includes a simplified block diagram of the solid fill unit 59. FIG. 5 serves to illustrate another example of how an overlay image may be superimposed on a main image for display on a display device. FIG. 5 illustrates how an overlay image may be superimposed on a main image using fewer memory accesses and less power than is used with example of FIG. 2. In addition, this example permits the host to read the entire main image at any time.

Referring to FIG. 5, the solid fill unit 59 includes a manager unit 66, a selecting circuit 68, and a register 70. The manager unit 66 is coupled with the host interface 34 to permit it to receive instructions from the host 24. The manager unit 66 is also coupled with a selecting input to the selecting circuit 68. A first data input to the selecting circuit 68 is coupled with the register 70. The register 70 stores a single pixel that may be used with displaying the overlay image 60 in a particular position on the display screen 26a. A second data input to the selecting circuit 68 is coupled with the frame buffer 46. When the display pipe 48a makes read requests for image data, the responses to such requests are presented to the second data input to the selecting circuit 68. The selecting circuit 68 includes an output which is coupled with an input to the display pipe 48a.

In FIG. 5, an overlay image 60 and a main image 62 are stored in the frame buffer 46. Like FIG. 2, the overlay image 60 may be a frame of video data received from the image sensor 28, and the main image 62 may be a computer generated frame of image data received from the host 24. The main image 62 may be stored in the frame buffer 46 as described above. However, unlike the example shown in FIG. 2, the main image 62 does not include the single-colored portion 64

Operation of the system 20 when the solid fill unit 59 is employed is described next. As in the example of FIG. 2, to render an image, the display pipes 48a and 48b fetch image data from the frame buffer 46. The display pipe 48a requests pixels of the main image 62 in a raster order corresponding to the main image, and the display pipe 48b requests pixels of the overlay image 60 in a raster order corresponding to the overlay image. Again, it is not critical that the display pipes fetch data in raster order; fetching may occur in any desired sequence.

Each main image pixel requested by the display pipe 48a is presented to the second data input (“1”) to the selecting circuit 68 in the solid fill unit 59. For each pixel fetched by display pipe 48a, the manager unit 66 determines whether the location of the fetched pixel corresponds with the location of an overlay image pixel. If the fetched main image pixel does not correspond with the location of an overlay image pixel, the manager unit 66 selects the second input of the selecting circuit 68 to pass the fetched main image pixel to the input of the display pipe 48a. On the other hand, if the fetched main image pixel does correspond with the location of an overlay image pixel, the manager unit 66 selects the first input (“0”) of the selecting circuit 68. Selection of the first input of the selecting circuit 68 causes the pixel stored in register 70 to be copied to the input of the display pipe 48a.

Each pixel of the main image 62 has an associated a coordinate position in the main image. In one embodiment, the manager unit 66 tracks the coordinate position of the fetched pixel in the main image 62. The manager unit 66 may determine whether the location of the fetched pixel corresponds with the location of an overlay image pixel by comparing the row and column coordinates of the fetched pixel with the coordinates that define position of the overlay image on the display screen.

Each pixel of the main image 62 also has an associated a position in an ordered sequence of pixels of the main image. In an alternative embodiment, the manager unit 66 tracks the position of the fetched pixel within the ordered sequence in which the main image 62 is received or read. The manager unit 66 may determine whether the location of the fetched pixel corresponds with the location of an overlay image pixel by comparing the sequential position of the fetched pixel with one or more ranges of sequential positions that correspond with the desired position of the overlay image on the display screen (expressed in terms of the ordered sequence). For instance, assume that the main image is a 10×10 array of pixels, the overlay image is a 5×5 array of pixels, and the overlay image is positioned to overlay the upper right-hand portion of the main image. In addition, assume the pixels of the main image are numbered sequentially in raster order. Under these assumptions the following range of sequential positions are occupied by the overlay image: 1-5, 11-15, 21-25, 31-35, and 41-45. If the location of a fetched pixel corresponds with a pixel position within one of these ranges, the manager unit 66 determines that the fetched pixel corresponds with the desired location of an overlay image pixel.

The manager unit 66 has access to location parameters that define the position where the overlay image 60 is to appear on the display screen 26a. These parameters may be stored in a register (not shown). The location parameters may be in the form of one or more (x, y) coordinates, or one or more ranges of sequential positions.

In one embodiment, the manager unit 66 determines whether the location of a fetched pixel corresponds with the location of an overlay image pixel as pixels are read from the frame buffer 46. In particular, when the display pipe 48a completes a read of a particular pixel, the manager unit 66 determines if the fetched pixel corresponds with the location of an overlay image pixel at substantially the same time the read operation is completed. For example, the determination may be made in the same clock cycle as the read operation. In another example, the determination may be made in the clock cycle immediately subsequent to the read operation. If the fetched pixel corresponds with the location of an overlay image pixel, the manager unit 66 selects the pixel stored in the register 70 to be copied to the input of the display pipe 48a at substantially the same time that the read operation is completed. On the other hand, if the fetched pixel does not correspond with the location of an overlay image pixel, the manager unit 66 selects the fetched pixel to be copied to the input of the display pipe 48a at substantially the same time that the read operation is completed.

When pixels are output from the display pipes 48a, 48b, the process for selecting a pixel from one pipe or the other is the same as described above with respect to the example of FIG. 2. Pixels output from the pipe 48a are compared with the value of a particular pixel, e.g., the pixel stored in register 70. This comparison may be made by the comparator 56. If the output pixel matches the color of the particular pixel, the comparator 56 selects a pixel from the display pipe 48b for presentation to the display interface 38. On the other hand, if the output pixel does not match the particular pixel, the comparator 56 selects the pixel from the display pipe 48a for presentation to the display interface 38.

The location where the overlay image will appear on the display screen 26a is determined by the location parameters that define the position of the overlay image. To move the location where the overlay image 60 appears on the display screen 26a, new location parameters corresponding to the new location are provided to the solid fill unit 59.

When the solid fill unit 59 is employed, the memory accesses associated with storing the single colored portion 64 in memory are eliminated. Moreover, use of the solid fill unit 59 eliminates the memory accesses associated with storing of the main image or a portion of the main image when the overlay image is moved. The number of memory accesses that are eliminated may be substantial. Use of the solid fill unit 59 also permits the host to read back any part of or the entire main image.

In one embodiment, a method according to the present disclosure begins with receiving a first sequence of data. The first sequence includes the pixel data of the main image 62 arranged in a particular order, such as raster, rotated raster, reverse raster, or interlaced scan order. The pixel data of the main image 62 may represent an image comprised of icons, buttons, task bars, text, etc. as described above. However, the pixel data of the main image 62 typically does not include a pixel having a particular value. In one embodiment, the main image 62 does not include a pixel having the particular value. The particular value may be the color value of the single-colored portion 64, as one example. The method includes determining whether the pixel data of the main image 62 are within the region of the main image that is to be overlaid with the overlay image 60. The method also includes replacing each pixel of the first sequence that is within the region with the pixel having the particular value. As a result of these steps, a second sequence of pixel data is created. The second sequence is arranged in the same order as the first sequence. The second sequence differs from the first sequence in that it includes pixel data of both the main image 62 and overlay image 60, the data of the overlay image replacing some of the pixels of the main image as described.

The main image 62 may comprise pixel data that correspond with all of the pixels in a display device. In one embodiment, the main image 62 comprises two-dimensional pixel data, as distinguished from three-dimensional pixel data. Each position in the first sequence may be associated with a row and column or (x, y) coordinate position in the main image 62 or with the pixels in the display screen 26a. The region where the overlay image is to replace the main image or is to be displayed on the display screen may be defined by one more of such parameters. As a result of this step, a third sequence of pixel data may be created.

As mentioned, the main image 62 comprises pixel data that correspond with all of the pixels in a display device. In one alternative embodiment, the region where the overlay image is to replace the main image or is to be displayed on the display screen may be defined by at least two sequential positions in the first sequence. For example, if the region is defined by the range of sequential positions 1-5, the region may be defined by positions 1 and 5. A method according to the present disclosure may include a step of replacing each pixel of the second sequence having the particular value with a pixel of the overlay image 60. In one embodiment, the overlay image 60 comprises two-dimensional pixel data, as distinguished from three-dimensional pixel data. As a result of this step, a third sequence of pixel data may be created.

While the solid fill unit 59 has been described as a unit that is separate from other units in the display controller 22, it is not critical that the functions it performs or the method embodiments described in the present disclosure be performed by the solid fill unit 59 or by a distinct unit. In one embodiment, the structure and functions of the solid fill unit 59 may be incorporated in the display pipe 48a. In another embodiment, methods and apparatus according to the present disclosure may be practiced in the display pipe 48a. In another alternative, embodiments of the present disclosure may be practiced in a memory controller (not shown) that controls access to the frame buffer 46.

In examples presented in this disclosure, the overlay and main images 60, 62 are stored in the frame buffer in the same arrangement in which the pixels are rendered on the display screen. This presentation is for convenience of explanation. It is not critical that the overlay and main images 60, 62 be stored in the frame buffer in any particular arrangement. In addition, in examples presented in this disclosure, the overlay image 60 is rectangular. It is not critical, however, that the overlay image 60 be rectangular or any other shape. In other embodiments, the overlay image 60 may be any two-dimensional shape desired, such as polygons other than a rectangle, or a circular or other shape having one or more curved sides.

In examples presented in this disclosure, the main image 62 is of a size which fills the entire display screen 26a and the overlay image 60 fills an area that is smaller than the entire display screen 26a. In addition, the main image 62 may be static for relatively long periods of time, while the overlay image 60 may be updated relatively frequently. For instance, the main image 62 may change when a telephone call or an electronic message is received, or a user issues an instruction, whereas the video image 60 may be updated at video frame rate such as twenty-four or thirty frames per second. However, it is not critical that either the main or overlay images 62, 60 be limited to any particular size or be updated with any particular frequency. In one embodiment, the main image 62 fills a portion of the entire display screen 26a.

Method embodiments of the present disclosure may be implemented in hardware or software, or in a combination of hardware and software. Where all or part of a method is implemented in software, a program of instructions may include one of more steps of a method and the program may be embodied on machine-readable media for execution by a machine. Machine-readable media may be magnetic, optical, or mechanical. A few examples of machine readable media include floppy disks, Flash memory, optical disks, bar codes, and punch cards. Some examples of a machine include disk drives, processors, USB drives, optical drives, and card readers. The foregoing examples are not intended to be exhaustive lists of media and machines. In one embodiment, a method according to the present disclosure may be practiced in a computer system, such as the computer system 20.

Embodiments of the claimed inventions may be used in a “mobile device.” A mobile device, as the phrase is used in this description and the claims, means a computer or communication system, such as a mobile telephone, personal digital assistant, digital music player, digital camera, or other similar device. Embodiments of the claimed inventions may be employed in any device capable of processing image data, including but not limited to computer and communication systems and devices generally.

The term “display device” is used in this description and the claims to refer to any of device capable of rendering images. For example, the term display device is intended to include hardcopy devices, such as printers and plotters. The term display device additionally refers to all types of display devices, such as LCD, CRT, LED, OLED, and plasma devices, without regard to the particular display technology employed.

In this document, the terms “fetch” or “read” have been used to refer to the action or operation of transferring data from one point to another, such as from a memory to a host. The terms have been used interchangeably with the intent that they be given the same meaning by the reader.

In this document, particular structures, processes, and operations well known to the person of ordinary skill in the art may not be described in detail in order to not obscure the description. As such, embodiments of the claimed inventions may be practiced even though such details are not described. On the other hand, certain structures, processes, and operations may be described in some detail even though such details may be well known to the person of ordinary skill in the art. This may be done, for example, for the benefit of the reader who may not be a person of ordinary skill in the art. Accordingly, embodiments of the claimed inventions may be practiced without some or all of the specific details that are described.

In this document, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

I claim:

1. A method comprising the steps of:
receiving a first sequence of data of a first frame, the first sequence being in a particular order and each datum of the first frame having a value that is distinct from a particular value;
determining whether the data of the first frame are within a region of the first frame; and
replacing each datum of the first sequence that is within the region with the datum having the particular value, thereby creating a second sequence of data.

2. The method of claim 1, wherein the first frame comprises pixel data that corresponds with all of the pixels in a display device.

3. The method of claim 1, wherein the first frame comprises two-dimensional pixel data that corresponds with all of the pixels in a display device.

4. The method of claim 3, wherein each position in the sequence is associated with a coordinate position in the first frame and the region is defined by at least one coordinate position in the first frame.

5. The method of claim 4, further comprising a step of replacing each datum of the second sequence having the particular value with a datum of a second frame, the second frame comprising two-dimensional pixel data, thereby creating a third sequence of data.

6. The method of claim 1, wherein the region is defined by at least two sequential positions in the first sequence.

7. The method of claim 6, further comprising a step of replacing each datum of the second sequence having the particular value with a datum of a second frame, the second frame comprising two-dimensional pixel data, thereby creating a third sequence of data.

8. An apparatus comprising:
a first unit to receive a first frame, to replace each datum of the first frame with a datum having a particular value if the datum of the first frame is within a region of the first frame, thereby creating a second frame, and to write the second frame.

9. The apparatus of claim 8, further comprising a first memory, wherein the first unit receives the first frame by reading the first frame from the first memory.

10. The apparatus of claim 9, wherein each datum of the first frame has a value that is distinct from the particular value.

11. The apparatus of claim 10, wherein the first frame is a first size and comprises pixel data that corresponds with all of the pixels in a display device, and the first memory has a capacity that is sufficient to store a quantity equal to at least the first size but less than twice the first size.

12. The apparatus of claim 8, further comprising a second memory, wherein the first unit writes the second frame to the second memory at a first clock rate, and the second unit outputs the second frame at a second clock rate, the first and second clock rates being distinct.

13. The apparatus of claim 8, further comprising a second memory, wherein the first memory writes the second frame to the second memory, the first frame being a first size and comprising pixel data that corresponds with all of the pixels in a display device, and the second memory has a capacity that is sufficient to store a quantity which is less than one percent of the first size.

14. The apparatus of claim 8, wherein, for each datum of the first frame, the first unit completes a read of a particular datum and, if the particular datum is within the region, replaces the particular datum with the datum having the particular value at substantially the same time.

15. The apparatus of claim 8, further comprising a second unit to replace each datum of the second frame having the particular value with a datum of a third frame, thereby creating a fourth frame.

16. A system comprising:
a first memory to receive data of a first frame in a particular sequence, to determine if each datum of the first frame is within a region of the first frame, and to store a datum having a particular value if the datum is within the region and otherwise to store the datum.

17. The system of claim 16, further comprising a display device to render an image of a particular size, wherein the first frame is a first size and comprises pixel data that corresponds with all of the pixels of display device.

18. The system of claim 17, wherein the first memory has a capacity to store a quantity which is less than one percent of the first size.

19. The system of claim 18, wherein the first memory reads data of the first frame at a first clock rate and outputs data at a second clock rate, the first and second clock rates being distinct.

20. The system of claim 19, further comprising a second memory to store the first frame, each datum of the first frame having a value that is distinct from the particular value, and a host to issue an instruction to specify the region and to cause the first memory to read the first frame from the second memory.

21. The system of claim 20, further comprising a unit to replace each datum output by the first memory having the particular value with a datum of a second frame, each datum of the second frame having a value that is distinct from the particular value.

22. The system of claim 21, wherein the system is a mobile device.
